(19) United States
(12) Patent Application Publication
(10) Pub. No.: US 2008/0207050 A1
(43) Pub. Date: Aug. 28, 2008

(54) COAXIAL CABLE CONNECTOR

(76) Inventor: Chi-Hua Wang, Tainan City (TW)

Correspondence Address: Chi-Hua WANG, P.O. Box 90, Tainan City, 70499, TW

(21) Appl. No.: 11/680,574

(22) Filed: Feb. 28, 2007

(51) Int. Cl. H01R 9/05

(52) U.S. Cl. 439/578

(57) ABSTRACT

A coaxial cable connector consists of a case, an insulator, a first conducting pin and a second conducting pin. The case includes an accommodating room. The insulator is installed in the accommodating room, including a chamber, two plugging grooves cut at two sides of and communicating with the chamber, a guiding rail in the chamber, a guiding groove cut in the guiding rail, and a plugging hole bored at its one end to communicate with the guiding groove. The plugging grooves are respectively inserted with the first and the second conducting pin. The first conducting pin has a pair of connecting pins formed vertically to face each other at its one end. The second conducting pin has its one end bent to form a contact portion.

### BACKGROUND OF THE INVENTION

1. Field of the Invention

This invention relates to a coaxial cable connector, particularly to one merely consisting of a case, an insulator, a first conducting pin and a second conducting pin, having simple components for saving manufacturing cost and assembling time.

2. Description of the Prior Art

Commonly, as shown in FIGS. 1˜3, a conventional coaxial cable connector 1 is provided with an outer casing 10, a first insulating body 11 and a second insulating body 12 set in the outer casing 10. The first insulating body 11 is provided with a chamber 110 and a plugging hole 111 located in one end of the chamber 110. The second insulating body 12 is provided with a recess 120 inside it, and two through holes 121 and 122 dug axially for a first conducting pin 13 and a second conducting pin 14 to pass through into the chamber 110 of the first insulating body 11. The first conducting pin 13 is provided with a contact portion 130 located at its front end for contacting with a cable plugging terminal 17, and a contact projection 131 pressed inwards from a proper location. The second conducting pin 14 is also provided with a contact projection 141 pressed inwards corresponding to the contact projection 131. The coaxial cable connector 1 is additionally provided with a spring 15 and a pushing member 16 having a guiding bar 160 for fitting with the spring 15, installed in the recess 120 of the second insulating body 12. The pushing member 16 is also provided with a conducting flange 161 located in front of the guiding bar 160 for contacting with the contact projections 131 and 141 of the first conducting pin 13 and the second conducting pin 14, keeping the first conducting pin 13 and the second conducting pin 14 connected. Connected in front of the conducting flange 161 is a needle 162 positioned in the chamber 110 of the first insulating body 11 to exactly correspond to the plugging hole 111. As shown in FIG. 3, when the cable plugging terminal 17 is plugged in the plugging hole 111 of the first insulating body 11, it is to push the needle 162 to keep the pushing member 16 moved toward the second insulating body 12, enabling the conducting flange 161 to come off the contact projections 131 and 141 to keep the first conducting pin 13 and the second conducting pin 14 disconnected. By the time, the spring 15 is elastically compressed by the pushing member 16 and the cable plugging terminal 17 has pushed up the contact portion 130 to contact with the first conducting pin 13 to keep the first conducting pin 13 connected again, enabling the electrical signal of the cable to be connected with the equipment, achieving the purpose of automatically jumping to connect the signal in the connector. But, the conventional coaxial cable connector has so many components that it involves not only a high cost for manufacture, but also a time-consuming assembly.

### SUMMARY OF THE INVENTION

The objective of this invention is to offer a coaxial cable connector.

The main characteristics of the invention are a case, an insulator, a first conducting pin and a second conducting pin. The case includes an accommodating room. The insulator is installed in the accommodating room, provided with a chamber, two plugging grooves cut at two sides of and communicating with the chamber, a guiding rail in the chamber, a guiding groove cut in the guiding rail, and a plugging hole bored at its one end to communicate with the guiding groove. The first conducting pin is inserted through one of the plugging groove of the insulator, provided with a pair of connecting pins formed vertically to face each other at its one end, positioned in the chamber and mounted above and below the guiding rail. The second conducting pin is inserted through the other plugging groove of the insulator, having its one end bent to form a contact portion for contacting with the connecting pins of the first conducting pin.

### BRIEF DESCRIPTION OF DRAWINGS

This invention is better understood by referring to the accompanying drawings, wherein:

FIG. 1 is an exploded perspective view of a conventional coaxial cable connector;

FIG. 2 is a side cross-sectional view of the conventional coaxial cable connector;

FIG. 3 is a side cross-sectional view of the conventional coaxial cable connector, showing it being used;

FIG. 4 is an exploded perspective view of a preferred embodiment of a coaxial cable connector in the present invention;

FIG. 5 is a perspective view of the preferred embodiment of a coaxial cable connector in the present invention;

FIG. 6 is a side cross-sectional view of the preferred embodiment of a coaxial cable connector in the present invention;

FIG. 7 is a side cross-sectional view of the preferred embodiment of a coaxial cable connector in the present invention, showing it being used;

FIG. 8 is a front cross-sectional view of the preferred embodiment of a coaxial cable connector in the present invention; and

FIG. 9 is a front cross-sectional view of the preferred embodiment of a coaxial cable connector in the present invention, showing it being used.

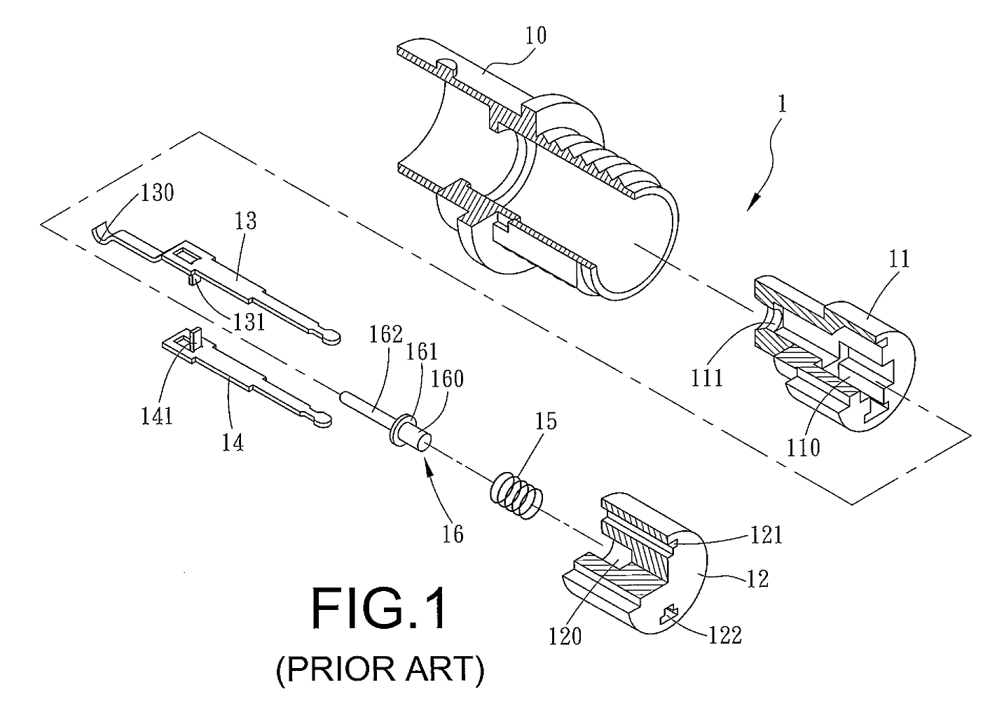

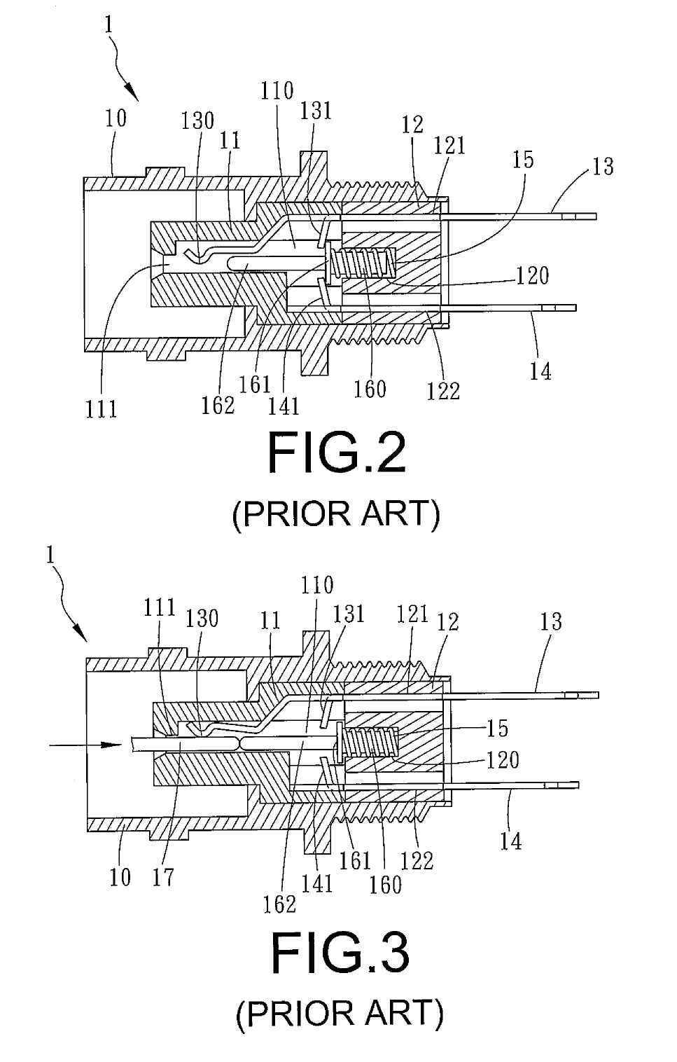

### DETAILED DESCRIPTION OF THE PREFERRED EMBODIMENT

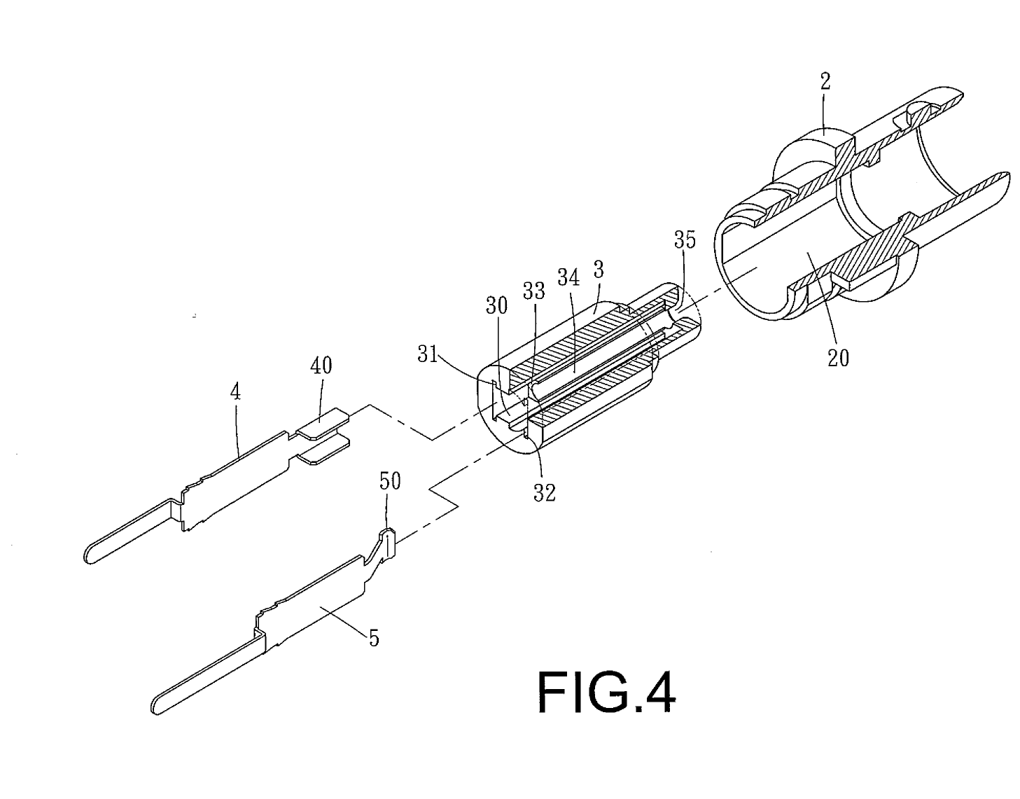

As shown in FIGS. 4, 6 and 8, a preferred embodiment of a coaxial cable connector in the present invention is composed of a case 2, an insulator 3, a first conducting pin 4 and a second conducting pin 5. The case 2 includes an accommodating room 20. The insulator 3 installed in the accommodating room 20 of the case 2 is provided with a chamber 30, two plugging grooves 31 and 32 cut at two sides of and communicating with the chamber 30, a guiding rail 33 in the chamber 30, a guiding groove 34 cut in the guiding rail 33, and a plugging hole 35 bored at its one end to communicate with the guiding groove 34. The first conducting pin 4 is inserted through the plugging groove 31 of the insulator 3, provided with a pair of connecting pins 40 formed vertically to face each other at its one end. The second conducting pin 5 is inserted through the plugging groove 32 of the insulator 3, having its one end bent to form a contact portion 50.

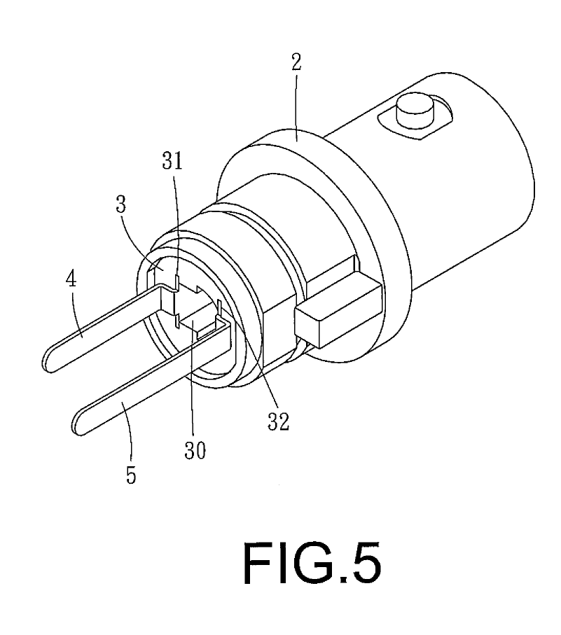

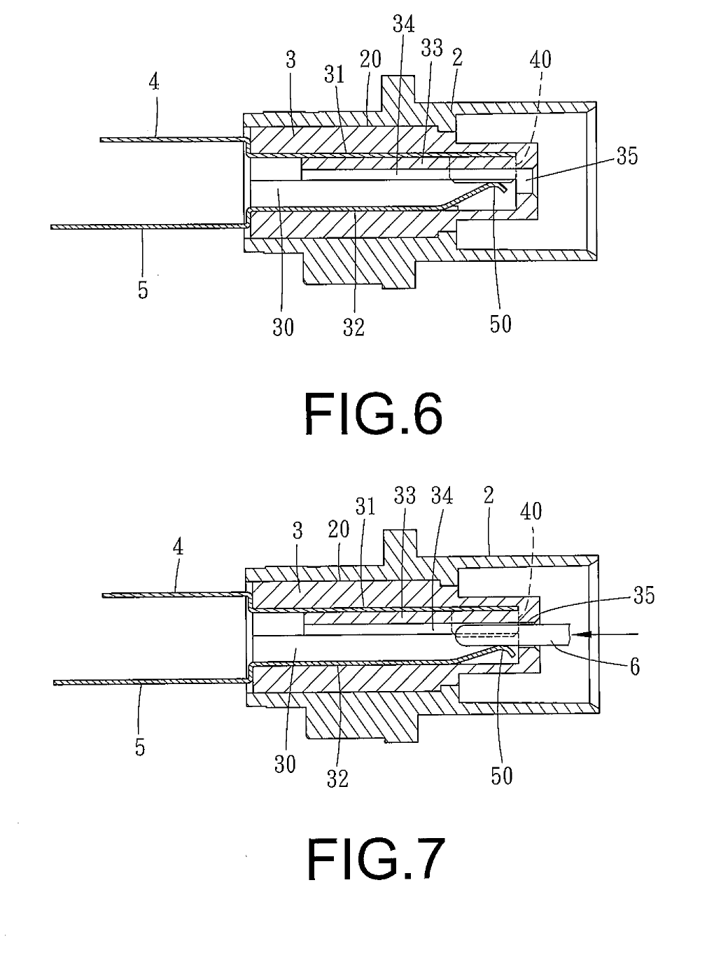

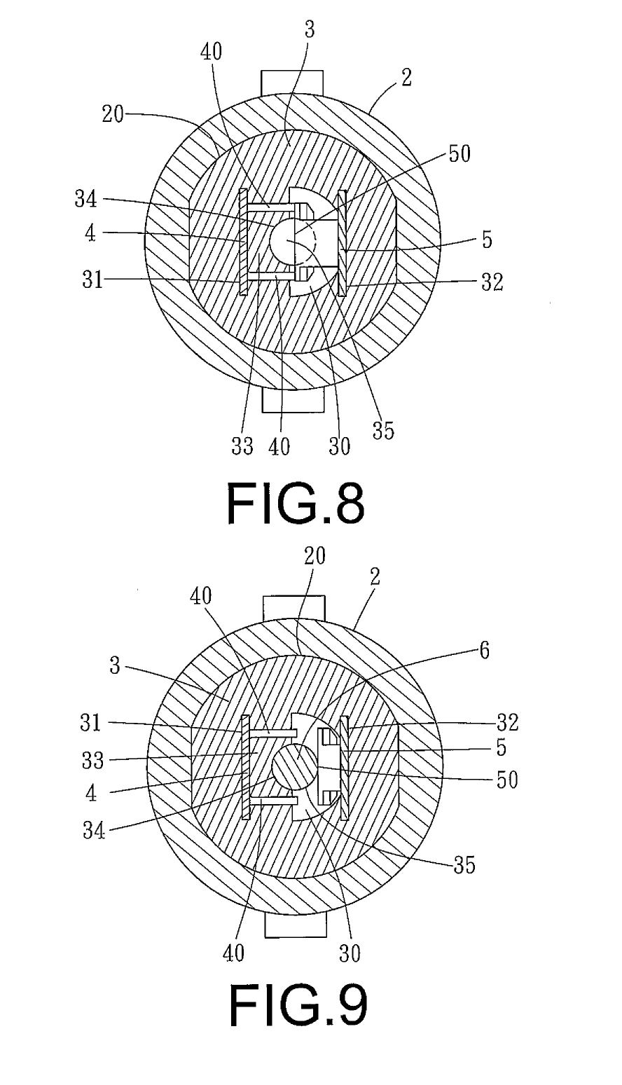

In assembly, as shown in FIGS. 4, 5, 6 and 8, the insulator 3 is first installed in the accommodating room 20 of the case 2. Next, the first conducting pin 4 is inserted through the plugging groove 31, keeping the connecting pins 40 positioned in the chamber 30 and mounted above and below the guiding rail 33. Then, the second conducting pin 5 is inserted through the plugging groove 32, keeping the contact portion 50 connected with the bottom edges of the connecting pins 40 to enable the first conducting pin 4 connected with the second conducting pin 5, as shown in FIGS. 6 and 8. By the time, the assembly of the invention is finished, not only very simple but also saving time.

In using, as shown in FIGS. 6˜9, when the plugging terminal 6 of a cable is plugged into the plugging hole 35 of the insulator 3, it is to move along the guiding groove 34 of the guiding rail 33 to push the contact portion 50 of the second conducting pin 5 away from the connecting pins 40 elastically, as shown in FIGS. 7 and 9, disconnecting the first conducting pin 4 from the second conducting pin 5. By the time, the contact portion 50 of the second conducting pin 5 is in contact with the plugging terminal 6, which is isolated by the guiding rail 33 to be spaced apart from the first conducting pin 4. Therefore, the electrical signal of the cable is connected with the end of the equipment, achieving the purpose of automatically jumping to connect the signal in the invention, with simple components for saving cost and facilitating assembly.

While the preferred embodiment of the invention has been described above, it will be recognized and understood that various modifications may be made therein and the appended claims are intended to cover all such modifications that may fall within the spirit and scope of the invention.

1. A coaxial cable, connector comprising:
a case provided with an accommodating room;
an insulator installed in said accommodating room of said case and provided with a chamber, two plugging grooves dug at two sides of and communicating with said chamber, a guiding rail in said chamber, a guiding groove cut in said guiding rail and a plugging hole dug in its one end to communicate with said guiding groove;
a first conducting pin inserted through one of said plugging grooves of said insulator and; the first conducting pin having a main body and a pair of connecting pins; the pair of connecting pins being formed at two sides of one end of the main body of the first conducting pin; each connecting pin being an approximately rectangular sheet which is vertical to and connected with the main body of the first conducting pin; and the two pins being approximately parallel to one another so that the two pins and the end of the main body of the first conducting pin being formed as an approximate U shape trench; the main body being formed as an approximate [symbol] (a Chinese words with a pronunciation of “an”) shape; said connecting pins positioned in said chamber of said insulator to mount above and below the guiding rail; and
a second conducting pin inserted through the other plugging groove of the insulator and the second conducting pin having an [symbol] (a Chinese words with a pronunciation of “an”) shape and having its one end bent to form a contact portion 50 for contacting with said first conducting pin.
